(19) United States
(12) Patent Application Publication
(10) Pub. No.: US 2017/0111879 A1
(43) Pub. Date: Apr. 20, 2017

(54) RESOURCE CONTROL FOR WIRELESS DEVICE DETACH

(71) Applicants: Haomin LI, Kanata (CA); Randika BALASOORIYA, Ottawa (CA); Nadiia TYMOSHENKO, Krakow (PL)

(72) Inventors: Haomin LI, Kanata (CA); Randika BALASOORIYA, Ottawa (CA); Nadiia TYMOSHENKO, Krakow (PL)

(73) Assignee: TELEFONAKTIEBOLAGET LM ERICSSON (PUBL), Stockholm (SE)

(21) Appl. No.: 14/906,070

(22) PCT Filed: Dec. 22, 2015
(86) PCT No.: PCT/IB2015/059900

§ 371 Date: Jan. 19, 2016

Related U.S. Application Data
(60) Provisional application No. 62/153,751, filed on Apr. 28, 2015.

(51) Int. Cl. H04W 60/06; H04W 60/04; H04W 76/06

(52) U.S. Cl. CPC H04W 60/06; H04W 76/06; H04W 60/04

(57) ABSTRACT

The present disclosure provides an efficient method and system for controlling resources of a wireless device during a detach procedure in a wireless communication network. According to a broad aspect of the disclosure, there is provided a method for a control node for controlling resources for a UE in a wireless network. The method includes receiving a detach message from the UE that contains a detach type for the detach. When the detach type for the detach is indicative of a switch off, the method includes sending a release message with a first detach indication to an access node to release one or more resources associated with the UE. When the detach type for the detach is not indicative of a switch off, the method includes sending the release message with a second detach indication to the access node to release the one or more resources associated with the UE.

### TECHNICAL FIELD

The present disclosure relates to detach procedures and more particularly to resource control during a detach procedure of a wireless device.

### BACKGROUND

In a cellular radio system (such as, by way of non-limiting example, 3GPP, LTE, 3G and 4G), wireless terminals (also known as mobile stations and/or User Equipment units (UEs)) communicate via a radio access network (RAN) to one or more core networks (such as, by way of non-limiting example, the Evolved Packet Core (EPC) network).

UEs may be (by way of non-limiting example) mobile telephones (“cellular” telephones), desktop computers, laptop computers, tablet computers, and/or any other devices with wireless communication capability to communicate voice and/or data with a RAN. In order to gain access to a core network services, the UE first selects an access node (e.g. an eNodeB) in the RAN to communicate with and then goes through an attach procedure to establish a connection with the core network. In a Long Term Evolution (LTE) network for example, the UE performs an attach procedure with a Mobility Management Entity (MME), a control node in the EPC responsible for managing access and mobility in an LTE network. Once attached, the UE can access the EPC for packet services in an Evolved Packet System (EPS).

In an LTE network, the attach is an EPS Mobility Management (EMM) procedure performed at the Non-Access Stratum (NAS) layer. The procedure is specified in section 5.5.1 of 3GPP Technical Specification (TS) 24.301, Universal Mobile Telecommunications System (UMTS), LTE, NAS protocol for Evolved Packet System (EPS), Stage 3, version 12.7.0 dated January 2015, hereinafter referred to as “TS 24.301” and incorporated herein by reference in its entirety. The procedure begins with the transmission of an Attach Request from the UE. In order to complete, the attach procedure first requires the establishment of a Radio Resource Control (RRC) connection at the RRC layer between the UE and eNB as well as an S1 signaling connection over the S1-MME interface between the eNB and the MME. With these connections established, the UE's Attach Request can be delivered to the MME as a NAS message embedded in an RRC message when passing through the RRC connection, and then in a S1 Application Protocol (S1AP) message through the S1 signaling connection. The RRC and S1 signaling connections also otherwise referred to as an EPS Connection Management (ECM) connection, form a NAS signaling connection between the UE and MME with which the UE can perform the NAS attach procedure to connect to the MME.

When it receives an Attach Request, the MME authenticates the UE (and associated subscriber) and performs NAS security setup procedures for securing the delivery of NAS messages to and from the UE. If these procedures are successful, the MME sends an Attach Accept message back to the UE and establishes an EPS session with dedicated network/radio bearer resources to enable the UE to gain access to core network services via the EPC.

An attached UE may detach from the network for a variety of reasons and the detach may be triggered by the UE or the network. A detach initiated by the network (e.g. by the MME or the HSS) may, for example, occur because of a change in the UE subscriber profile, network maintenance, re-authentication failure, allocated resources becoming unavailable or poor radio link quality. A UE-triggered detach may occur when, for example, the UE is attempting to use a non-EPS service (e.g. CS fallback, SMS, etc.), a Subscriber Identity Module (SIM) or Universal Integrated Circuit Card (UICC) card is removed from the UE or simply when the UE is switched off.

Similarly to the attach procedure, the detach is also an EMM procedure performed at the NAS layer. Details of a conventional 3GPP detach procedure are specified in section 5.5.2 of 3GPP TS 24.301 (incorporated herein by reference). In that example, the detach procedure begins with the transmission of a NAS Detach Request message to the MME. When it receives the Detach Request, the MME sends a UE Context Release Command message to the eNB over the S1 signaling connection. Because it is a termination point for the S1 connection with the MME, the eNB is able to receive the UE Context Release Command message and release the resources assigned to the UE via the RRC layer.

### SUMMARY

The present disclosure provides an efficient method and system for controlling resources of a wireless device during a detach procedure in a wireless communication network.

According to a broad aspect of the disclosure, there is provided a method for a control node for controlling resources for a UE in a wireless network. The method includes receiving a detach message from the UE that contains a detach type for the detach. When the detach type for the detach is indicative of a switch off, the method includes sending a release message with a first detach indication to an access node to release one or more resources associated with the UE. When the detach type for the detach is not indicative of a switch off, the method includes sending the release message with a second detach indication to the access node to release the one or more resources associated with the UE.

In this aspect, in some embodiments, the method includes determining whether the detach type is indicative of a switch off. In some other embodiments, the control node includes a Mobility Management Entity (MME) node, the detach message includes a DETACH REQUEST message and the release message includes a UE Context Release Command message. In yet some other embodiments, the detach type includes one of a switch off detach value indicative of a switch off detach request by the UE and a non-switch off detach value indicative of a non-switch off detach request by the UE.

In yet some other embodiments, the first detach indication includes a switch off detach indication indicative of a UE switch off detach and the second detach indication includes a non-switch off detach indication indicative of a UE non-switch off detach. In yet some other embodiments, the detach message includes a NAS message, the first and second detach indications include NAS causes, the access node includes an eNB node, and the one or more resources comprises one or more of an RRC connection and a UE context.

According to another broad aspect of the disclosure, there is provided a control node that includes circuitry containing instructions which, when executed, cause the control node to perform the method described above.

According to yet another broad aspect of the disclosure, there is provided a method for an access node for controlling resources for a UE in a wireless network. The method includes receiving a release message from a control node to release one or more resources associated with the UE where the release message contains a detach indication. The method further includes sending a resource release message to the UE to release the one or more resources associated with the UE when the detach indication includes a non-switch off detach indication.

In some embodiments, the method further includes determining that the detach indication includes a non-switch off detach indication. In yet some other embodiments, the non-switch off detach indication is indicative of a UE non-switch off detach. In yet some other embodiments, the detach indication is a NAS cause and the one or more resources comprises an RRC connection. In yet some other embodiments, the access node includes an eNB node, the control node includes an MME node, the release message includes a UE Context Release Command message and the resource release message includes an RRC connection release message.

According to yet another broad aspect of the disclosure, there is provided an access node that includes circuitry containing instructions which, when executed, cause the access node to perform the method described above.

According to yet another broad aspect of the present disclosure, there is provided a method for an access node for controlling resources for a UE in a wireless network. The method includes receiving a release message from a control node to release one or more resources associated with the UE where the release message contains a detach cause indicative of a UE detach. The method further includes determining whether a detach response message for the UE has been received from the control node, and sending a resource release message to the UE to release the one or more resources associated with the UE when a determination is made that no detach response message has been received from the control node.

In some implementations, the detach cause is a NAS cause and the one or more resources comprises an RRC connection. In some other embodiments, the detach response message includes a NAS DETACH ACCEPT message and to determine whether a detach response message has been received from the control node, the method further includes determining whether the release message includes the NAS DETACH ACCEPT message. In yet some other implementations, to determine whether a detach response message has been received from the control node, the method further includes determining whether a NAS DETACH ACCEPT message separate from the release message has been received from the control node. In yet some other implementations, the access node includes an eNB node, the control node includes an MME node, the release message includes a UE Context Release Command message and the resource release message includes an RRC connection release message.

According to another broad aspect of the disclosure, there is provided an access node that includes circuitry containing instructions which, when executed, cause the access node to perform the method described above.

### BRIEF DESCRIPTION OF THE DRAWINGS

Example embodiments of the present disclosure will now be described by reference to the following figures, in which identical reference numbers in different figures indicate identical elements, and in which:

FIG. 1 is a signaling diagram demonstrating an example method of a non-switch off detach procedure initiated by a User Equipment (UE) in a Long Term Evolution (LTE) Radio Access Network (RAN) according to one example embodiment of the present disclosure;

FIG. 2 is a signaling diagram demonstrating an example method of a switch off detach procedure initiated by the UE of FIG. 1;

FIG. 3 shows an example method for an Mobility Management Entity (MME) for controlling resources of a UE during the UE-initiated detach procedures shown in FIGS. 1 and 2;

FIG. 4 shows an example method for an eNodeB (eNB) for controlling resources of a UE during the UE-initiated detach procedure shown in FIGS. 1 and 2;

FIG. 5 shows another example method for an eNodeB (eNB) for controlling resources of a UE during a UE-initiated detach procedure according to another embodiment of the present disclosure;

FIG. 6 shows an example method for a control node for controlling resources of a UE during an UE-initiated detach procedures according to yet another embodiment of the present disclosure;

FIG. 7 shows an example method for an access node for controlling resources of a UE during an UE-initiated detach procedure according to yet another embodiment of the present disclosure;

FIG. 8 shows another example method for an access node for controlling resources of a UE during an UE-initiated detach procedure according to yet another embodiment of the present disclosure;

FIG. 9A, 9B show a block diagram of an exemplary embodiment of a control node and an access node configured in accordance with principles of the present disclosure; and

FIG. 10A, 10B show a block diagram of another exemplary embodiment of a control node and an access node configured in accordance with principles of the present disclosure.

### DETAILED DESCRIPTION

The present disclosure provides methods and related apparatus for the control of resources associated with a wireless device in a wireless communication network during a detach procedure.

Generally, the present disclosure applies to detach procedures (or other disconnect procedures) initiated by a wireless device (also known as a User Equipment or UE in 3GPP). The procedure is normally carried out with the assistance of a control node in a core network which may be an Mobility Management Entity (MME) as well as an access node which may be a serving node or more generally a node with which the UE is connected or attached. The access node may be a Node B (NB), evolved Node B (eNB), base station, wireless access point (AP), base station controller (BSC), radio network controller (RNC), relay, donor node controlling relay, base transceiver station (BTS), transmission point, transmission node, remote RF unit (RRU), remote radio head (RRH), etc.

The wireless device or UE may be any type of device capable of at least communicating through wireless communication. The wireless device may be, for example a wireless terminal (also known as a mobile stations, a mobile phone (“cellular” phone), a desktop, laptop, netbook, and/or tablet computer, a laptop embedded equipment (LEE), laptop mounted equipment (LME), or a portable device such as an e-book reader, watch, digital music and/or video player, camera, game controller and/or device but also may be a computing-like device such as a hart monitoring implant, biochip transponder, automobile, sensor, modem, thermostat, and/or other home or car appliance generally referred to as an Internet of Things (IoT) device, a machine type communication (MTC) device (also known as a machine-to-machine (M2M) or device-to-device (D2D) device).

The following description will now be presented in the context of a Long Term Evolution (LTE) Radio Access Network (RAN) infrastructure but it is to be understood that it is not limited as such and the concepts presented herein may be applied to other 4^{th} Generation (4G), 5^{th} Generation (5G) or other future generations of a 3GPP communication network infrastructure. More generally, the present disclosure applies to any current or future wireless and core network infrastructures configured to perform detach or disconnect procedures for a UE.

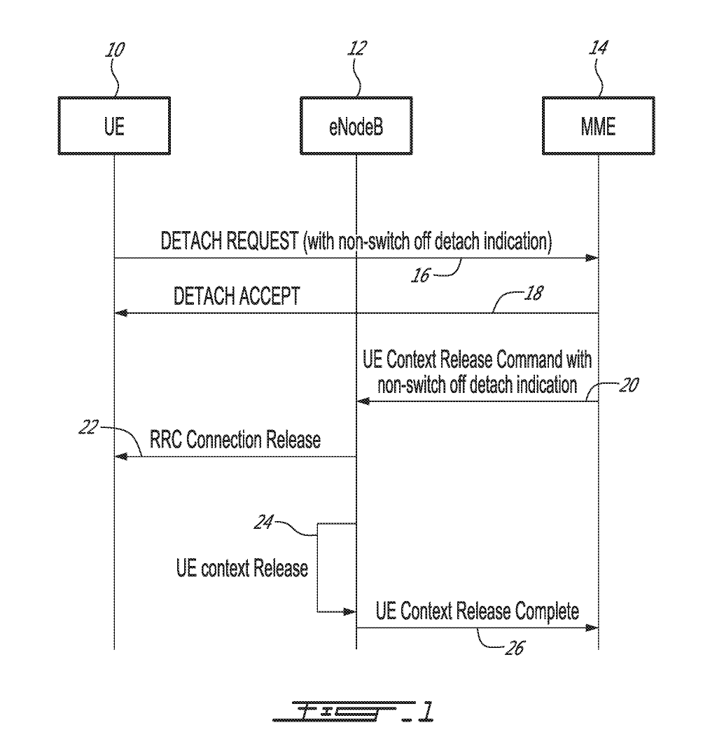

Turning now to FIG. 1, there is shown an example method of a non-switch off detach procedure initiated a UE 10 in an LTE RAN (not shown) according to one example embodiment of the present disclosure. Generally, the detach procedure involves Non-Access Stratum (NAS) signaling between the UE 10 and an MME 14 in a core network (not shown) connected to the RAN LTE as well as S1 signaling between the MME 14 and an eNB 12 to which the UE 10 is connected in the LTE RAN and between the eNB 12 and UE 10.

There are many scenarios which may trigger the UE 10 to initiate a detach. These may include when the UE 10 is attempting to use a non-EPS service (e.g. CS fallback, SMS, etc.), when a Subscriber Identity Module (SIM) or Universal Integrated Circuit Card (UICC) card is removed from the UE, or when the UE 10 is being switched off. In the example of FIG. 1, the detach procedure initiated by the UE 10 is not a switch off detach i.e. a detach which is not the result of the UE 10 turning or switching off.

As is conventional in a non-switch off detach scenario, the detach procedure begins at step 16 with the UE 10 sending a DETACH REQUEST message to the MME 14. The DETACH REQUEST message is a NAS message sent over a previously established NAS signaling connection between the UE 10 and the MME 14. The DETACH REQUEST message includes an indication that the detach requested by the UE 10 is not the result of a switch off. Such “non-switch off” indication may be implemented in many different ways. For example, the indication could be in the form of a cause indication, an Information Element (IE) or detach type. In the example of FIG. 1, the non-switch off indication is implemented as a bit or flag in a detach type IE set to 0 to indicate that the DETACH REQUEST message sent is a result of a normal detach (e.g. a detach not the result of a switch off). Other implementations for the non-switch off indication are possible.

At step 18, upon receiving the DETACH REQUEST message with, for example, a detach type IE set to indicate a normal or non-switch off detach, the MME 14 sends a DETACH ACCEPT message to the UE 10. The DETACH ACCEPT message is also a NAS message sent via the NAS signaling connection. In response to receiving the DETACH REQUEST message with a non-switch off indication (e.g. a detach type indicative of a non-switch off detach or not indicative of a switch off), the MME 14 sends a UE Context Release Command message over the S1 signaling connection at step 20 to instruct or request the eNB 12 to release resources assigned to the UE 10 which includes the release of the UE-associated S1-logical connection over the S1 interface.

In some embodiments, the detach procedure may be implemented as specified in section 5.5.2 of 3GPP Technical Specification (TS) 24.301, Universal Mobile Telecommunications System (UMTS), LTE, NAS protocol for Evolved Packet System (EPS), Stage 3, version 12.7.0 dated January 2015, herein referred to as 3GPP TS 24.301 and section 8.3.3, of 3GPP TS 36.413, Evolved Universal Terrestrial Radio Access Network (E-UTRAN); S1 Application Protocol (S1AP), version 12.4.0, dated February 2015, herein referred to as “TS 36.413” both of which are incorporated herein by reference in their entirety.

In 3GPP, the eNB 12 may not be aware of the reason why the MME 14 may be requesting the release of resources. This is particularly true as the release is caused by a NAS-based detach procedure which the eNB 12 is not a terminating point. If the UE 10 initiates a detach as a result of a switch off for example, the eNB 12 may not know that the UE 10 is no longer available for signaling and may unnecessarily attempt to send (and re-send) signaling messages to the UE 10 to release its resources.

According to an embodiment of the present disclosure, the UE Context Release Command message includes a cause or other indication indicative of a reason for the particular UE Context Release Command message sent. As shown in FIG. 1, in the case where the detach is a result of a non-switch off, the indication is set to be indicative of a non-switch off (or normal) detach. With this non-switch off detach indication, the eNB 12 (which is not configured to be a termination point for NAS signaling and therefore would not otherwise know that the NAS detach procedure initiated is not the result of a switch off) is now able to determine that the UE 10 has not been switched off and is still available to receive (RRC) signaling messages.

In one embodiment, the non-switch off detach indication is implemented as a (NAS) Cause IE set to indicate the reason for a particular event for the S1AP protocol. In another embodiment, the non-switch off detach indication is implemented as a NAS cause (or other cause type) and formatted as specified in section 9.2.1.3 of TS 36.413. An example of such format is as follows:

| | | | | |
|---|---|---|---|---|
| | | | IE Type and | Semantics |
| IE/Group Name | Presence | Range | Reference | Description |

| | |
|---|---|
| CHOICE Cause | M |
| Group | |

>NAS

| | | |
|---|---|---|
| >>NAS | M | ENUMERATED |
| Cause | | (Normal Release, |

Authentication
failure,
Detach,
Unspecified,
. . . ,
CSG Subscription
Expiry)

In yet another embodiment, the non-switch off detach cause is one of a plurality of NAS causes as recited in section 9.2.1.3 of TS 36.413 and is referred to as a NAS “Detach” cause indicative of an action or event due to a (normal) detach:

| NAS cause | Meaning |
|---|---|
| Normal Release | The release is normal. |
| Authentication | The action is due to |
| Failure | authentication failure. |
| Detach | The action is due to detach. |
| Unspecified | Sent when none of the above |
| | cause values applies but |
| | still the cause is NAS related. |
| CSG Subscription | The action is due to the UE |
| Expiry | becoming a non-member of |
| | the currently used CSG. |
| Detach Switch | The action is due to detach with |
| Off | “switch off” indication. |

In yet another embodiment, the non-switch off detach indication included in the UE Context Release Command message is implemented as a NAS-related indication or IE. In one example, the NAS-related IE is a Detach Type IE formatted as follows:

| | | | | |
|---|---|---|---|---|
| | | | IE type and | Semantics |
| IE/Group Name | Presence | Range | reference | description |

| | | |
|---|---|---|
| Detach Type | M | ENUMERATED |
| | | (normal detach, |
| | | detach with |
| | | switch-off, |
| | | . . .) |

The Detach Type IE indicates whether the detach is a normal detach (a non-switch off detach) or a detach where the UE has already switched off. In the example of FIG. 1, the Detach Type IE is set to a normal (or non-switch off) detach value which is indicative of a non-switch off detach (e.g. detach not the result of a switch off).

At step 22, based on the UE Context Release Command message received and in particular the indication included which, in this case is indicative of a non-switch off detach, the eNB 12 sends a RRC Connection Release message to the UE 10 to release the RRC connection between the UE 10 and the eNB 12. In addition, the eNB 12 also proceeds to release (or delete) its stored UE context at step 24 and sends a UE Context Release Complete message at step 26 to the MME 14 to confirm that the UE resources (e.g. the RRC connection and UE context) have been released. It is to be understood that the above described detach procedure may include additional steps or details some of which may be as described in section 5.5.2 of TS 24.301 and section 8.3.3 of TS 36.413.

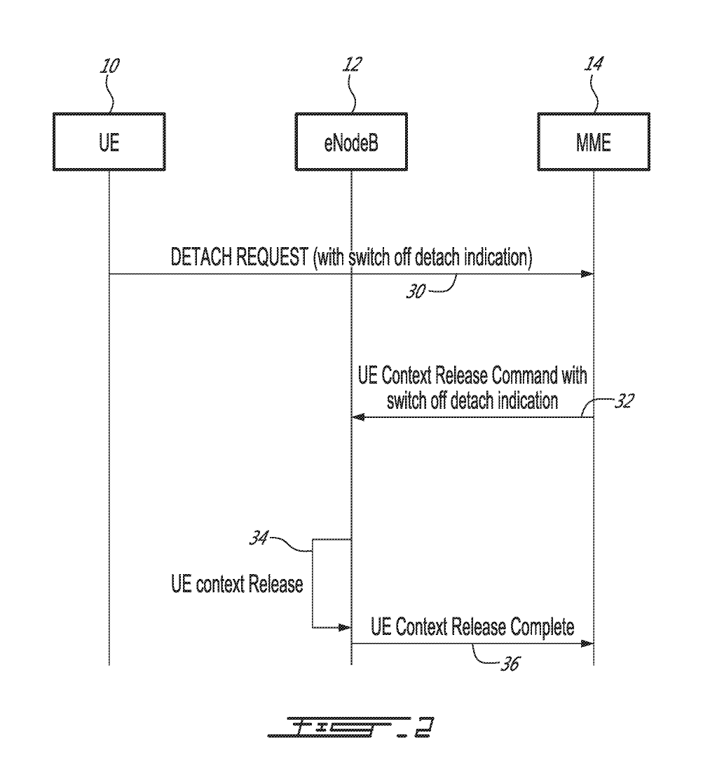

FIG. 2 shows an example method of another detach procedure initiated by the UE 10 which, in this example is the result of a switch off. The switch off detach procedure example of FIG. 2 begins at step 30 with the UE 10 sending a DETACH REQUEST message to the MME 14 over the NAS signaling connection. In this example, the DETACH REQUEST message includes an indication that the detach requested by the UE 10 is the result of a switch off. Similarly to the non-switch off indication, the “switch off” indication may be implemented in many different ways. For example, the indication could be in the form of a cause indication, an Information Element (IE) or detach type. In the example of FIG. 2, the switch off indication is implemented as a bit or flag in a detach type IE set to 1 to indicate that the DETACH REQUEST message sent is a result of a switch off detach (e.g. a detach which is the result of a switch off). Other implementations for the switch off indication are possible.

In response to receiving the DETACH REQUEST message with a switch off indication (e.g. a detach type indicative of a switch off), the MME 14 sends a UE Context Release Command message over the S1 signaling connection at step 32 to instruct or request the eNB 12 to release resources assigned to the UE 10 which includes the release of the UE-associated S1-logical connection over the S1 interface. According to an embodiment of the present disclosure, the UE Context Release Command message includes a cause or other indication indicative of a reason for the particular UE Context Release Command message sent. In the example of FIG. 2, the indication is set to be indicative of a switch off (detach). With this indication, the eNB 12 (which is not configured to be a termination point for NAS signaling) is now able to determine that the UE 10 has already been switched off and is not available to receive (RRC) signaling messages. As a result of this determination, the eNB 12 will not unnecessarily attempt to send (and re-send) an RRC Connection Release message to the UE 10 to release its RRC connection.

At step 34, the eNB 12 proceeds to release (or delete) its stored UE context at step 24 and sends a UE Context Release Complete message at step 26 to the MME 14 to confirm that the UE resources (e.g. the UE context) have been released. It is to be understood that the above described detach procedure may include additional steps or details some of which may be as described in section 5.5.2 of TS 24.301 and section 8.3.3 of TS 36.413

In one embodiment, the switch off (detach) indication is implemented as a (NAS) Cause IE set to indicate the reason for a particular event for the S1AP protocol. In another embodiment, the switch off detach indication is implemented as a NAS cause (or other cause type) and formatted as specified in section 9.2.1.3 of TS 36.413 (see above). In yet another embodiment, the switch off detach cause is one of a plurality of NAS causes as recited in section 9.2.1.3 of TS 36.413 and is referred to as a NAS “Detach Switch Off” cause indicative of an action or event due to a detach with “switch off” indication:

| NAS cause | Meaning |
|---|---|
| Normal Release | The release is normal. |
| Authentication | The action is due to |
| Failure | authentication failure. |
| Detach | The action is due to detach. |
| Unspecified | Sent when none of the above |
| | cause values applies but |
| | still the cause is NAS related. |
| CSG Subscription | The action is due to the UE |
| Expiry | becoming a non-member of |
| | the currently used CSG. |
| Detach Switch | The action is due to detach with |
| Off | “switch off” indication. |

In yet another embodiment, the switch off detach indication included in the UE Context Release Command message is implemented as a NAS-related indication or IE. In one example, the NAS-related IE is a Detach Type IE formatted as follows:

| | | | | |
|---|---|---|---|---|
| | | | IE type and | Semantics |
| IE/Group Name | Presence | Range | reference | description |

| | | |
|---|---|---|
| Detach Type | M | ENUMERATED |
| | | (normal detach, |
| | | detach with |
| | | switch-off, |
| | | . . .) |

As noted above, the Detach Type IE indicates whether the detach is a normal detach (a non-switch off detach) or a detach where the UE has already switched off. In the example of FIG. 2, the Detach Type IE is set to a detach with switch-off value which is indicative of a switch off detach (e.g. a detach which is the result of a switch off).

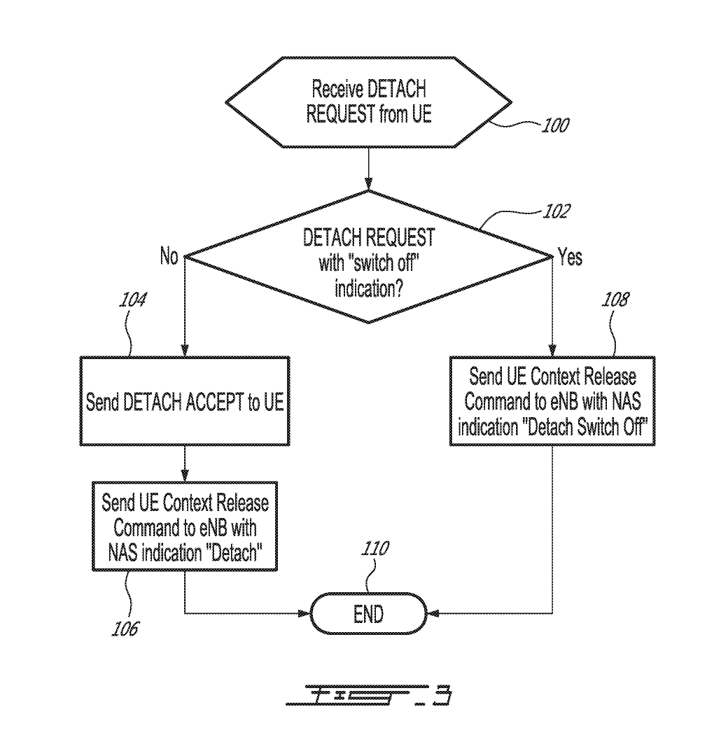

FIG. 3 shows an example method for the MME 14 for controlling resources of the UE 10 during the UE-initiated detach procedures shown in FIGS. 1 and 2. The method begins at step 100 where the MME 14 receives a DETACH REQUEST message from the UE 10. At step 102, the MME 14 determines whether the DETACH REQUEST message includes a switch off indication. If the MME 14 determines that the DETACH REQUEST message includes a switch off indication or a detach type indicating a switch off, it sends a UE Context Release Command message to the eNB with a NAS detach switch off indication to indicate a switch off detach by the UE 10. Otherwise, if the MME 14 determines that the DETACH REQUEST message does not include a switch off indication (or includes instead a non-switch off indication or a detach type not indicative of a switch off), it sends a DETACH ACCEPT message to the UE 10 and sends a UE Context Release Command message to the eNB with a NAS detach indication to indicate a non-switch off detach by the UE 10. The method of FIG. 3 ends at step 110.

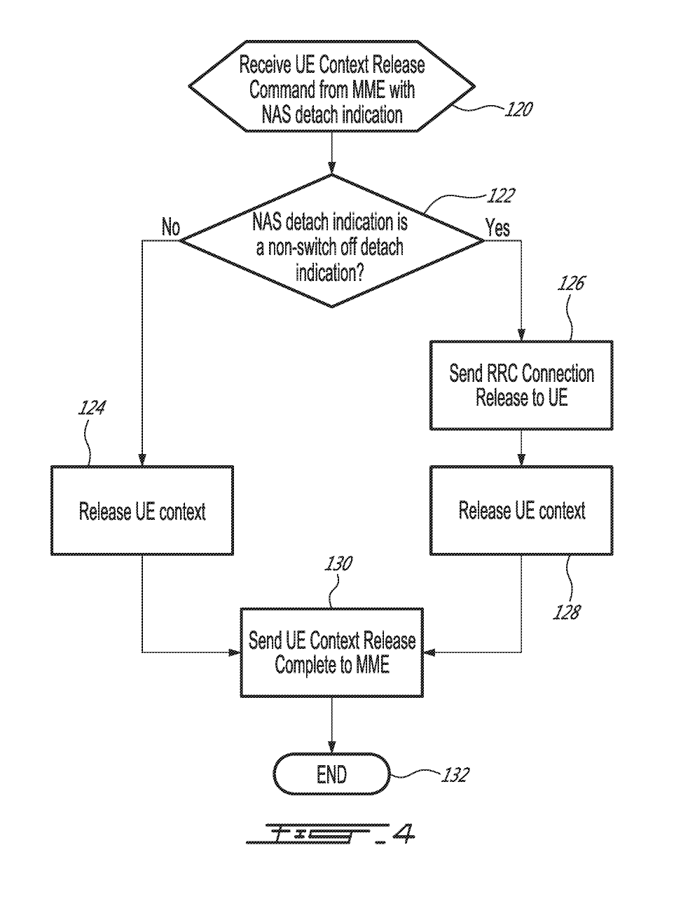

FIG. 4 shows an example method for the eNB 12 for controlling resources the UE 10 during the UE-initiated detach procedure shown in FIGS. 1 and 2. The method begins at step 120 where the eNB 12 receives a UE Context Release Command from the MME 14 with a NAS detach indication or cause. At step 122, the eNB 12 determines whether the NAS detach indication included in the UE Context Release Command is a non-switch off detach indication. If it determines that the NAS detach indication is a non-switch off detach indication, the eNB 12 assumes that the UE 10 has not switched off and is available to receive signaling messages and as such, it sends an RRC connection Release message to the UE 10 at step 126 to release the RRC connection between the UE 10 and the eNB 12 and releases (e.g. deletes) the UE context at step 128.

If, on the other hand, it determines that the NAS detach indication or cause included in the UE Context Release Command message is not a non-switch off detach indication (e.g. and instead is a switch off detach indication), the eNB 12 assumes that the UE 10 has already switched off and is no longer available to receive signaling messages. As a result, the eNB 12 does not send any RRC connection Release message to the UE 10 and instead proceeds to release or delete the UE context at step 128. In other implementations, when it receives the UE Context Release Command from the MME 14 with a detach indication, the eNB 12 sends a RRC Connection Release message to the UE 10 only if or when the detach indication is a non-switch off detach indication.

After releasing the UE context, the eNB 12 in both cases sends a UE Context Release Complete message back to the MME 14 at step 130 to acknowledge the release of the UE resources. The method ends at step 132.

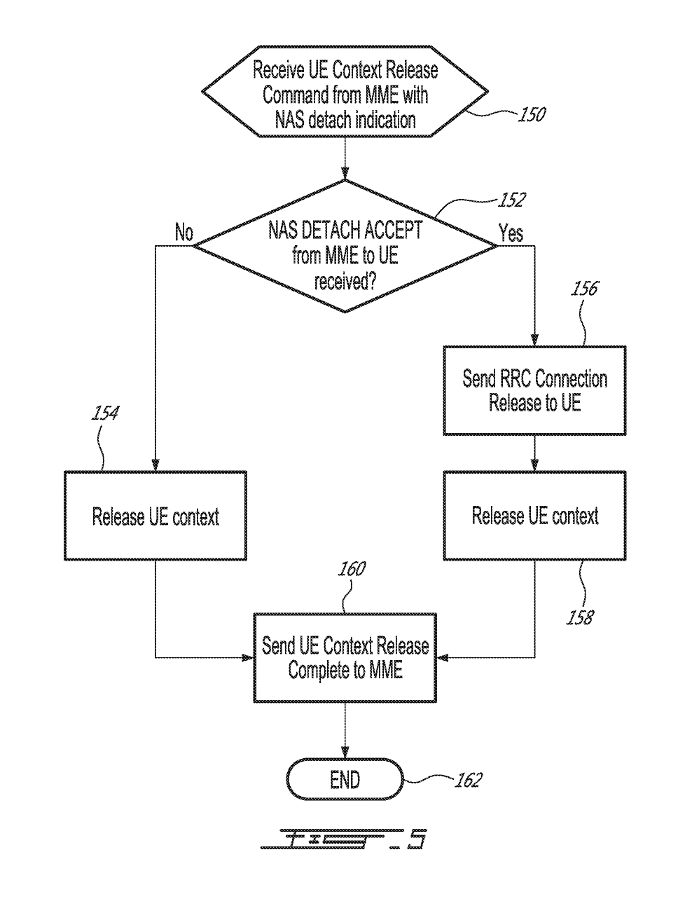

Turning now to FIG. 5, there is shown another example method for the eNB 12 for controlling resources of a UE during a UE-initiated detach procedure, in accordance with another embodiment of the present disclosure. Although not a NAS termination point, the eNB 12 is configured in this embodiment to monitor NAS transmissions related to UE-initiated detach procedures to distinguish between a switch off detach and a non-switch off detach.

At step 150, the eNB 12 receives a UE Context Release Command message with a (NAS) detach indication or cause from the MME 14. The eNB 12 then determines at step 152 whether it has received a DETACH ACCEPT message intended for the UE 10. In the particular example of FIG. 5, the DETACH ACCEPT message, if sent by the MME 14, is received as part of the payload of the UE Context Release Command message. In other implementations, if the DETACH ACCEPT message is sent as a separate S1AP transmission (e.g. distinct from the UE Context Release Command message transmission), the eNB 12 is configured to determine whether it has received a DETACH ACCEPT message in any S1AP transmission to/from the MME 14. It is to be noted that the eNB 12 could also be configured to monitor other NAS messages (e.g. the DETACH REQUEST message or a detach type value of the DETACH REQUEST message) exchanged between the UE 10 and MME 14 to distinguish between the two types of detach procedures. Other implementations are possible.

If it determines that it has received from the MME 14 a DETACH ACCEPT message intended for the UE 10 (for e.g. included in the UE Context Release Command message payload), the eNB 12 assumes that the UE 10 has not switched off and is available to receive signaling messages. As such, the eNB 12 sends an RRC connection Release message to the UE 10 at step 156 to release the RRC connection with the UE 10 and also releases (e.g. deletes) the UE context at step 158.

If, on the other hand, it determines that it has not received a DETACH ACCEPT message (e.g. no such message is included in the UE Context Release Command message), the eNB 12 assumes that the UE 10 has already switched off and is no longer available to receive signaling messages. As a result, the eNB 12 does not send any RRC connection Release message to the UE 10 and instead proceeds to release or delete the UE context at step 154. In other implementations, when it receives the UE Context Release Command from the MME 14 with a detach indication, the eNB 12 sends a RRC Connection Release message to the UE 10 only if or when the eNB 12 determines that it has received a NAS message indicating that detach is a result of non-switch off detach.

After releasing the UE context, the eNB 12 in both cases sends a UE Context Release Complete message back to the MME 14 at step 160 to acknowledge the release of the UE resources. The method ends at step 162.

According to principles of the present disclosure, the signaling described above provides NAS visibility to the eNB 12 that it normally would not have (because it is not a NAS terminating point) so that it can appropriately control or adjust its RRC signaling with the UE 10. By using different indications in the UE Context Release Command message or by configuring the eNB 12 to monitor NAS transmissions to distinguish between the detach types or causes for a detach, the eNB 12 is made aware (or is able to determine) the appropriate cause for the NAS detach procedure. As a result, the eNB 12 is able to determine whether the UE 10 has been switched off or not and whether it can send RRC signaling messages at to the UE 10. Without this knowledge, the eNB 12 might, for example, unnecessarily attempt to send the RRC Connection Release message to release the RRC connection. In some cases, it may even attempt to re-transmit multiple times and at different layers (which, depending on the eNB configuration could result in a large number of retransmissions), wasting valuable resources, possibly triggering various failures (e.g. HARQ, Discontinuous Transmission (DTX), Radio Link Control (RLC) failures) and delaying the UE context release and remainder of the detach procedure in the eNB 12.

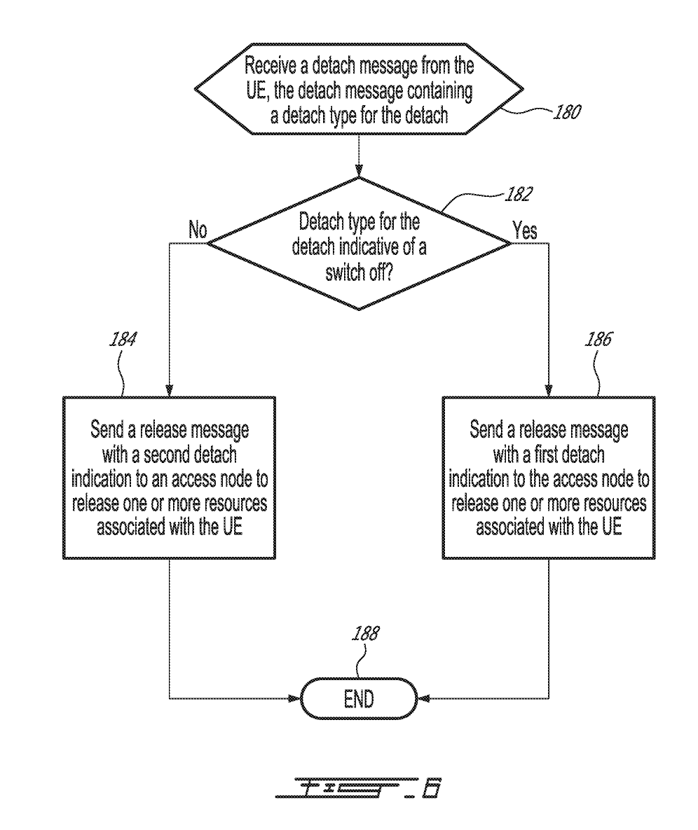

FIG. 6 shows an example method for a control node (e.g. the MME 14) for controlling resources of a UE during an UE-initiated detach procedures according to yet another embodiment of the present disclosure. The method begins at step 180 where the control node receives a detach message from the UE 10 that contains a detach type for the detach. At step 182, the control node determines whether the detach type for the detach is indicative of a switch off. If the control node determines that the detach type included in the detach message is indicative of a switch off (e.g. includes a switch off detach value indicative of a switch of detach request by the UE), it sends a release message with a first detach indication or cause (e.g. a switch off detach value indicative of a switch off detach) to an access node to release one or more resources associated with the UE. Otherwise, if the control node determines that the that the detach type included in the detach message is not indicative of a switch off (e.g. includes a non-switch off detach value indicative of a non-switch off detach request by the UE), it sends the release message with a second detach indication or cause (e.g. a non-switch off detach indication indicative of a UE non-switch off detach) to the access node to release the one or more resources associated with the UE. The method ends at step 188.

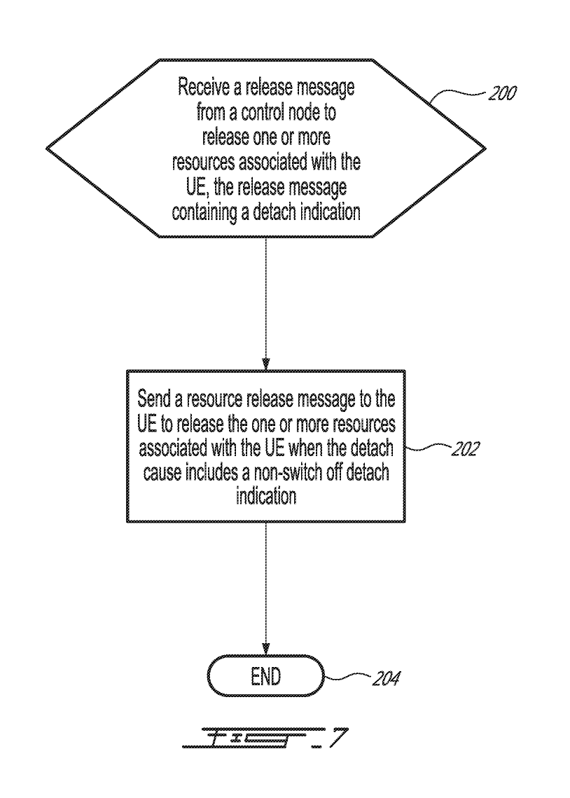

FIG. 7 shows an example method for an access node (e.g. the eNB 12) for controlling resources of a UE during an UE-initiated detach procedure according to yet another embodiment of the present disclosure. The method begins at step 200 where the access node receives a release message that includes a detach indication from a control node (e.g. the MME 14) to release one or more resources associated with the UE. At step 202, the access node sends a resource release message to the UE to release the one or more resources associated with the UE when the detach indication includes a non-switch off detach indication. In other implementations, when it receives the release message from the control node with a detach indication, the access node sends a resource release message to the UE 10 only if or when the detach indication includes a non-switch off detach indication. The method ends at step 204.

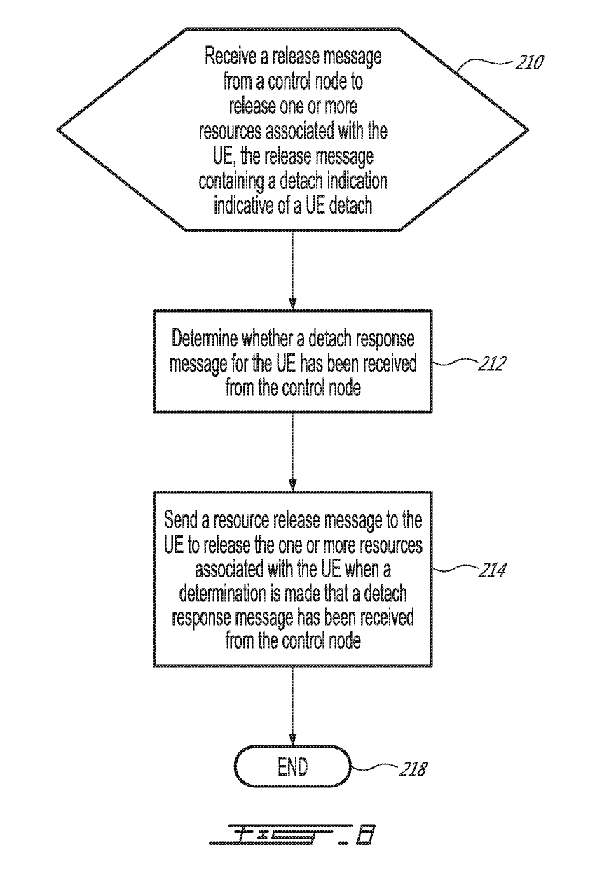

FIG. 8 shows another example method for an access node (e.g. the eNB 12) for controlling resources of a UE during an UE-initiated detach procedure according to yet another embodiment of the present disclosure. The access node is configured in this embodiment to monitor non-terminated layer transmissions (e.g. transmissions of an upper layer not terminated at the access node) related to UE-initiated detach procedures between a control node (e.g. the MME 14) and the UE to distinguish between a switch off detach and a non-switch off detach.

In the particular example of FIG. 8, the access node receives a release message from the control node at step 210 to release one or more resources associated with the UE. The release message includes a detach indication or cause indicative of a UE detach. At step 212, the access node determines whether a (NAS) detach response message for the UE (e.g. a DETACH ACCEPT message) has been received from the control node. The access node then proceeds to send a resource release message to the UE at step 214 to release the one or more resources associated with the UE when it determines that no detach response message has been received from the control node. In other implementations, when it receives the release message from the control node with a detach indication, the access node sends a resource release message to the UE 10 only if or when the access node determines that it has received a NAS message (e.g. a detach response message) indicating that detach is a result of non-switch off detach. The method ends at step 218.

According to principles of the present disclosure, the signaling described above provides an access node with non-terminating (upper) layer visibility that it normally would not have so that it can appropriately control or adjust its terminating (lower) layer signaling with the UE. By using different indications in a release message or by configuring the access node to monitor non-terminated layer transmissions to distinguish between the detach types or causes for a detach, the access node is made aware (or is able to determine) the appropriate cause for the detach procedure. As a result, the access node is able to determine whether the UE has been switched off or not and whether it can send signaling messages to the UE. Without this knowledge, the access node might unnecessarily attempt to send resource release messages to the UE to release its resources. In some cases, it may even attempt to re-transmit those messages multiple times and at different layers (which, depending on the access node configuration could result in a large number of re-transmissions), wasting valuable resources and possibly triggering various layer failures (e.g. HARQ, Discontinuous Transmission (DTX), Radio Link Control (RLC) failures) and delaying the rest of the detach procedure.

### Other Examples

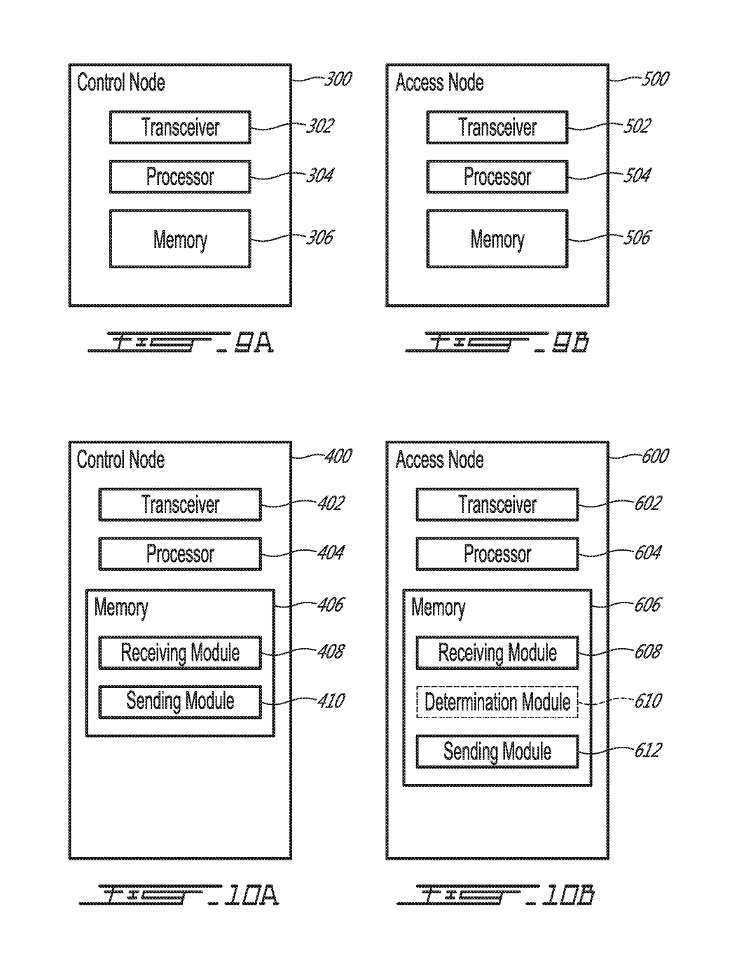

FIGS. 9A-B are block diagrams of exemplary embodiments of respectively a control node 300 and an access node 500 (such as those described above in relation to FIGS. 1-8) configured for the control of UE resources in accordance with principles of the present disclosure. Each of these nodes 300 and 500 includes a transceiver 302, 502, one or more processors 304, 504 and a memory 306, 506 containing (computer-implemented) instructions which when executed by the processor(s) 304, 504 cause their respective node 300, 500 to perform some or all of their respective node functionality described above. In another example, the processor(s) 304, 504 may be located within a single node 300, 500 or distributed across two or more nodes (e.g., the node 300, 500 and another node). In yet another embodiment, the processor(s) 304, 504 includes one or more hardware components (e.g., Application Specific Integrated Circuits (ASICs)) that provide some or all of their respective node functionality described above. In yet another embodiment, the processor(s) 304, 504 includes one or more hardware components (e.g., Central Processing Units (CPUs)), and some or all of their respective node functionality described above is implemented in software stored in, e.g., the memory 306, 506 and executed by the processor(s) 304, 504. In yet another embodiment, the processor(s) 304, 504 and memory 306, 506 form processing means or circuitry (not shown) configured to perform their respective node functionality described above. Other implementations are possible.

FIGS. 10A-B show a variant for each of the node examples of FIGS. 9A-B, denoted respectively as control node 400 and access node 600.

As illustrated in FIG. 10A, control node 400 includes a transceiver 402, one or more processor(s) 404, a memory 406 which includes a receiving module 408 and a sending module 410 and optionally a determination module (not shown). Similarly to the example nodes 300, 500 of FIGS. 9A-B, the transceiver 402, processor(s) 404 and memory 406 may be implemented in many different ways. For example, the transceiver 402 may be replaced by a transmitter and a receiver (not shown). In the example of FIG. 10A, the receiving module 408 is configured to perform receiving functionality described above in relation to the control node which, as noted above includes receiving a detach message from a UE that contains a detach type for the detach. The determination module is configured to perform the determination functionality described above in relation to the control node. Finally, the sending module 410 is configured to perform the sending functionality described above for the control node which, as described above, includes sending a release message with either a first or second detach cause to an access node depending on the detach type for the detach.

The sending and receiving modules 408, 410 (and the optional determination module) of the control node 400 are implemented at least partially in the memory 406 in the form of software or (computer-implemented) instructions executed by the processor(s) 404 within the node 400 or distributed across two or more nodes (e.g., the node 400 and another node). In another example, the processor(s) 404 includes one or more hardware components (e.g., ASICs) that provide some or all of the receiving and sending functionality described above. In another embodiment, the processor(s) 404 includes one or more hardware components (e.g. CPUs), and some or all of the receiving and sending functionality described above is implemented in software stored in, e.g., the memory 406 and executed by the processor 404. In yet another embodiment, the processor(s) 404 and memory 410 form circuitry or processing means (not shown) configured to perform the receiving, (determination) and sending functionality described above.

Turning now to FIG. 10B, access node 600 includes a transceiver 602, one or more processor(s) 604, a memory 606 which includes a receiving module 608, an optional determination module 610 and a sending module 612. Similarly to the example nodes 300, 500 of FIGS. 9A-B, the transceiver 602, processor(s) 604 and memory 606 may be implemented in many different ways. For example, the transceiver 602 may be replaced by a transmitter and a receiver (not shown). In the example of FIG. 10B, the receiving module 608 is configured to perform the receiving functionality described above in relation to the access node which, as noted above includes receiving a release message containing a detach cause from a control node to release one or more resources associated with the UE. The optional determination module 610 is configured to perform the determination functionality described above in relation to the access node which includes determining whether a detach response message has been received from the control node. Finally, the sending module 612 is configured to perform the sending functionality described above for the access node which includes sending a resource release message to the UE to release the one or more resources associated with the UE when certain conditions are met.

The sending and receiving modules 408, 410 are implemented at least partially in the memory 406 in the form of software or (computer-implemented) instructions executed by the processor(s) 404 within the node 400 or distributed across two or more nodes (e.g., the node 400 and another node). In another example, the processor(s) 404 includes one or more hardware components (e.g., ASICs) that provide some or all of the receiving and sending functionality described above. In another embodiment, the processor(s) 404 includes one or more hardware components (e.g. CPUs), and some or all of the receiving and sending functionality described above is implemented in software stored in, e.g., the memory 406 and executed by the processor 404. In yet another embodiment, the processor(s) 404 and memory 410 form circuitry or processing means (not shown) configured to perform the receiving and sending functionality described above.

### Other Contemplated Embodiments

According to a broad aspect of the disclosure, there is provided a method for a control node for controlling resources for a UE in a wireless network. The method includes receiving a detach message from the UE that contains a detach type for the detach. When the detach type for the detach is indicative of a switch off, the method includes sending a release message with a first detach indication to an access node to release one or more resources associated with the UE. When the detach type for the detach is not indicative of a switch off, the method includes sending the release message with a second detach indication to the access node to release the one or more resources associated with the UE.

In this aspect, in some embodiments, the method includes determining whether the detach type is indicative of a switch off. In some other embodiments, the control node includes a Mobility Management Entity (MME) node, the detach message includes a DETACH REQUEST message and the release message includes a UE Context Release Command message. In yet some other embodiments, the detach type includes one of a switch off detach value indicative of a switch off detach request by the UE and a non-switch off detach value indicative of a non-switch off detach request by the UE.

In yet some other embodiments, the first detach indication includes a switch off detach indication indicative of a UE switch off detach and the second detach indication includes a non-switch off detach indication indicative of a UE non-switch off detach. In yet some other embodiments, the detach message includes a NAS message, the first and second detach indications include NAS causes, the access node includes an eNB node, and the one or more resources comprises one or more of an RRC connection and a UE context.

According to another broad aspect of the disclosure, there is provided a control node that includes circuitry containing instructions which, when executed, cause the control node to perform the method described above.

According to yet another broad aspect of the disclosure, there is provided a control node for controlling resources for a UE in a wireless network. The control node includes a receiving module for receiving a detach message from the UE that contains a detach type for the detach. The control node also includes a sending module for sending a release message with a first detach indication to an access node to release one or more resources associated with the UE when the detach type for the detach is indicative of a switch off. The sending module is also for sending the release message with a second detach indication to the access node to release the one or more resources associated with the UE when the detach type for the detach is not indicative of a switch off.

In some embodiments, the control node includes a determination module for determining whether the detach type is indicative of a switch off. In some other embodiments, the control node includes a Mobility Management Entity (MME) node, the detach message includes a DETACH REQUEST message and the release message includes a UE Context Release Command message. In yet some other embodiments, the detach type includes one of a switch off detach value indicative of a switch off detach request by the UE and a non-switch off detach value indicative of a non-switch off detach request by the UE.

In yet some other embodiments, the first detach indication includes a switch off detach indication indicative of a UE switch off detach and the second detach indication includes a non-switch off detach indication indicative of a UE non-switch off detach. In yet some other embodiments, the detach message includes a NAS message, the first and second detach indications include NAS causes, the access node includes an eNB node, and the one or more resources comprises one or more of an RRC connection and a UE context.

According to yet another broad aspect, there is provided a method for an access node for controlling resources for a UE in a wireless network. The method includes receiving a release message from a control node to release one or more resources associated with the UE where the release message contains a detach indication. The method further includes sending a resource release message to the UE to release the one or more resources associated with the UE when the detach indication includes a non-switch off detach indication.

In some embodiments, the method further includes determining that the detach indication includes a non-switch off detach indication. In yet some other embodiments, the non-switch off detach indication is indicative of a UE non-switch off detach. In yet some other embodiments, the detach indication is a NAS cause and the one or more resources comprises an RRC connection. In yet some other embodiments, the access node includes an eNB node, the control node includes an MME node, the release message includes a UE Context Release Command message and the resource release message includes an RRC connection release message.

According to yet another broad aspect of the disclosure, there is provided an access node that includes circuitry containing instructions which, when executed, cause the access node to perform the method described above.

According to yet another broad aspect, there is provided an access node for controlling resources for a UE in a wireless network. The access node includes a receiving module for receiving a release message from a control node to release one or more resources associated with the UE where the release message contains a detach indication. The access node further includes a sending module for sending a resource release message to the UE to release the one or more resources associated with the UE when the detach indication includes a non-switch off detach indication.

In some embodiments, the access node further includes a determination module for determining that the detach indication includes a non-switch off detach indication. In yet some other embodiments, the non-switch off detach indication is indicative of a UE non-switch off detach. In yet some other embodiments, the detach indication is a NAS cause and the one or more resources comprises an RRC connection. In yet some other embodiments, the access node includes an eNB node, the control node includes an MME node, the release message includes a UE Context Release Command message and the resource release message includes an RRC connection release message.

According to yet another broad aspect, there is provided a method for an access node for controlling resources for a UE in a wireless network. The method includes receiving a release message from a control node to release one or more resources associated with the UE where the release message contains a detach cause indicative of a UE detach. The method further includes determining whether a detach response message for the UE has been received from the control node, and sending a resource release message to the UE to release the one or more resources associated with the UE when a determination is made that no detach response message has been received from the control node.

In some implementations, the detach cause is a NAS cause and the one or more resources comprises an RRC connection. In some other embodiments, the detach response message includes a NAS DETACH ACCEPT message and to determine whether a detach response message has been received from the control node, the method further includes determining whether the release message includes the NAS DETACH ACCEPT message. In yet some other implementations, to determine whether a detach response message has been received from the control node, the method further includes determining whether a NAS DETACH ACCEPT message separate from the release message has been received from the control node. In yet some other implementations, the access node includes an eNB node, the control node includes an MME node, the release message includes a UE Context Release Command message and the resource release message includes an RRC connection release message.

According to another broad aspect of the disclosure, there is provided an access node that includes circuitry containing instructions which, when executed, cause the access node to perform the method described above.

According to yet another broad aspect of the present disclosure, there is provided an access node for controlling resources for a UE in a wireless network. The access node includes a receiving module for receiving a release message from a control node to release one or more resources associated with the UE where the release message contains a detach cause indicative of a UE detach. The access node also includes a determination module for determining whether a detach response message for the UE has been received from the control node, and a sending module for sending a resource release message to the UE to release the one or more resources associated with the UE when a determination is made that no detach response message has been received from the control node.

In some implementations, the detach cause is a NAS cause and the one or more resources comprises an RRC connection. In some other embodiments, the detach response message includes a NAS DETACH ACCEPT message and to determine whether a detach response message has been received from the control node, the determination module is also for determining whether the release message includes the NAS DETACH ACCEPT message. In yet some other implementations, to determine whether a detach response message has been received from the control node, the determination module is also for determining whether a NAS DETACH ACCEPT message separate from the release message has been received from the control node. In yet some other implementations, the access node includes an eNB node, the control node includes an MME node, the release message includes a UE Context Release Command message and the resource release message includes an RRC connection release message.

It will be appreciated by persons skilled in the art that the present disclosure is not limited to what has been particularly shown and described herein above. A variety of modifications and variations are possible in light of the above teachings.

1-32. (canceled)

33. A control node for controlling resources for a User Equipment (UE) in a wireless network, the control node comprising circuitry containing instructions which, when executed, cause the node to:
receive a detach message from the UE, the detach message containing a detach type for the detach;
when the detach type for the detach is indicative of a switch off, sending a release message with a first detach indication to an access node to release one or more resources associated with the UE;
when the detach type for the detach is not indicative of a switch off, sending the release message with a second detach indication to the access node to release the one or more resources associated with the UE.

34. The control node of claim 33, wherein the instructions further cause the control node to determine whether the detach type is indicative of a switch off.

35. The control node of claim 33, wherein the control node comprises a Mobility Management Entity (MME) node, the detach message comprises a DETACH REQUEST message and the release message comprises a UE Context Release Command message.

36. The control node of claim 33, wherein the detach type comprises one of a switch off detach value indicative of a switch off detach request by the UE and a non-switch off detach value indicative of a non-switch off detach request by the UE.

37. The control node of claim 33, wherein the first detach indication comprises a switch off detach indication indicative of a UE switch off detach and wherein the second detach indication comprises a non-switch off detach indication indicative of a UE non-switch off detach.

38. The control node of claim 33, wherein the detach message comprises a Non-Access Stratum (NAS) message, the first and second detach indications each comprises a NAS cause, and the one or more resources comprises one or more of a Radio Resource Control (RRC) connection and a UE context.

39. A method for a control node for controlling resources for a UE in a wireless network, the method comprising:
receiving a detach message from the UE, the detach message containing a detach type for the detach,
when the detach type for the detach is indicative of a switch off, sending a release message with a first detach indication to an access node to release one or more resources associated with the UE, and
when the detach type for the detach is not indicative of a switch off, sending the release message with a second detach indication to the access node to release the one or more resources associated with the UE.

40. The method of claim 39 further comprising determining whether the detach type is indicative of a switch off.

41. The method of claim 39 wherein the control node comprises a Mobility Management Entity (MME) node, the detach message comprises a DETACH REQUEST message and the release message comprises a UE Context Release Command message.

42. The method of claim 39, wherein the detach type comprises one of a switch off detach value indicative of a switch off detach request by the UE and a non-switch off detach value indicative of a non-switch off detach request by the UE.

43. The method of claim 39, wherein the first detach indication comprises a switch off detach indication indicative of a UE switch off detach and wherein the second detach indication comprises a non-switch off detach indication indicative of a UE non-switch off detach.

44. The method of claim 39, wherein the detach message comprises a NAS message, the first and second detach indications each comprises a NAS cause, and the one or more resources comprises one or more of an RRC connection and a UE context.

45. An access node for controlling resources for a UE in a wireless network, the access node comprising circuitry containing instructions which, when executed, cause the access node to:
receive a release message from a control node to release one or more resources associated with the UE, the release message containing a detach indication, and
send a resource release message to the UE to release the one or more resources associated with the UE when the detach indication includes a non-switch off detach indication.

46. The access node of claim 45, wherein the instructions further cause the access node to determine that the detach indication includes a non-switch off detach indication.

47. The access node of claim 45, wherein the non-switch off detach indication is indicative of a UE non-switch off detach.

48. The access node of claim 45, wherein the detach indication is a NAS cause and the one or more resources comprises an RRC connection.

49. The access node of claim 45, wherein the access node comprises an evolved Node B (eNB) node, the control node comprises an MME node, the release message comprises a UE Context Release Command message and the resource release message comprises an RRC connection release message.

50. A method for an access node for controlling resources for a UE in a wireless network, the method comprising:
receiving a release message from a control node to release one or more resources associated with the UE, the release message containing a detach indication, and
sending a resource release message to the UE to release the one or more resources associated with the UE when the detach indication includes a non-switch off detach indication.

51. The method of claim 50 further comprising determining that the detach indication includes a non-switch off detach indication.

52. The method of claim 50, wherein the non-switch off detach indication is indicative of a UE non-switch off detach.

53. The method of claim 50, wherein the detach indication is a NAS cause and the one or more resources comprises an RRC connection.

54. The method of claim 50, wherein the access node comprises an eNB node, the control node comprises an MME node, the release message comprises a UE Context Release Command message and the resource release message comprises an RRC connection release message.

55. An access node for controlling resources for a UE in a wireless network, the access node comprising circuitry containing instructions which, when executed, cause the access node to:
receive a release message from a control node to release one or more resources associated with the UE, the release message containing a detach cause indicative of a UE detach,
determine whether a detach response message for the UE has been received from the control node, and
send a resource release message to the UE to release the one or more resources associated with the UE when a determination is made that no detach response message has been received from the control node.

56. The access node of claim 55, wherein the detach cause is a NAS cause and the one or more resources comprises an RRC connection.

57. The access node of claim 55 wherein the detach response message comprises a NAS DETACH ACCEPT message and wherein to determine whether a detach response message has been received from the control node, the instructions further cause the access node to determine whether the release message includes the NAS DETACH ACCEPT message.

58. The access node of claim 55 wherein to determine whether a detach response message has been received from the control node, the instructions further cause the access node to determine whether a NAS DETACH ACCEPT message separate from the release message has been received from the control node.

59. The access node of claim 55, wherein the access node comprises an eNB node, the control node comprises an MME node, the release message comprises a UE Context Release Command message and the resource release message comprises an RRC connection release message.

60. A method for an access node for controlling resources for a UE in a wireless network, the method comprising:
receiving a release message from a control node to release one or more resources associated with the UE, the release message containing a detach cause indicative of a UE detach,
determining whether a detach response message for the UE has been received from the control node, and
sending a resource release message to the UE to release the one or more resources associated with the UE when a determination is made that no detach response message has been received from the control node.

61. The method of claim 60, wherein the detach cause is a NAS cause and the one or more resources comprises an RRC connection.

62. The method of claim 60 wherein the detach response message comprises a NAS DETACH ACCEPT message and wherein to determine whether a detach response message has been received from the control node, the method further comprises determining whether the release message includes the NAS DETACH ACCEPT message.

63. The method of claim 60 wherein to determine whether a detach response message has been received from the control node, the method further comprises determining whether a NAS DETACH ACCEPT message separate from the release message has been received from the control node.

64. The method of 60, wherein the access node comprises an eNB node, the control node comprises an MME node, the release message comprises a UE Context Release Command message and the resource release message comprises an RRC connection release message.
